(19) United States
(12) Patent Application Publication
(10) Pub. No.: US 2015/0128247 A1
(43) Pub. Date: May 7, 2015

(54) CENTRALIZED DEVICE REPUTATION CENTER

(71) Applicant: FireBlade LTD., Tel Aviv (IL)

(72) Inventors: Shay Rapaport, Kfar Saba (IL); Erez Azaria, Gedera (IL)

(21) Appl. No.: 14/399,226

(22) PCT Filed: May 8, 2013
(86) PCT No.: PCT/IL13/50394

§ 371 Date: Nov. 6, 2014

Related U.S. Application Data
(60) Provisional application No. 61/643,903, filed on May 8, 2012.

(51) Int. Cl. H04L 29/06; H04L 12/26

(52) U.S. Cl. CPC H04L 63/0245; H04L 43/10
USPC 726/13

(57) ABSTRACT

A method and system for selective web traffic blocking are provided herein. The method may include: receiving a request from a user to receive a resource from a web server; collecting data from the received request; applying either background device inspection or foreground device inspection in response to the received request, based on the collected data; receiving fingerprint data in response to inspection; and providing a rule how to respond to the user based on the fingerprint data. The system comprises a service node to receive a request from a user to receive a resource from a web server, to collect data from the received request and to apply either background device inspection or foreground device inspection based on the collected data, and a centralized device reputation center to receive fingerprint data and to provide to said service node a rule how to respond to the user based on the fingerprint data.

### FIELD OF THE INVENTION

The present invention relates to a method and system for blocking web attackers and, more particularly, to a method and system for blocking illegitimate traffic, regardless of Internet Protocol (IP) address, while allowing legitimate traffic, regardless of IP address.

### BACKGROUND OF THE INVENTION

Websites and online platforms are exposed to various types of hostile traffic and attacks, such as for example, disallowed scraping and spying, web form spammers, application-level attacks, vulnerability scanning, password brute-forcing, and denial of service. These hostile attacks threaten online businesses and activities. Although most websites have taken the precaution to at least have some security measures in place, such as firewalls, intrusion prevention systems, web application firewalls and routine code reviews, many of these hostile attacks succeed.

Such hostile attacks typically succeed when (i) the attack source remains unveiled, and (ii) the attacking procedure has been automated. In this way, the attacker is able to make endless attempts on an attacked asset. It is then incumbent on the attacked asset to provide security measures that are able to recognize and block each and every attempt from attack sources.

Automation of online activities is a common practice in the present state of the art. This is accomplished primarily through the use of automation scripts, known as “Bots.” Anonymity is an inherent attribute of the majority of online activity; in most interactions, a server or an online service “knows” an end-user only as an Internet Protocol (IP) address, and possibly as a cookie (which can easily be deleted). Therefore, a security measure may block hostile attacks either by a single-request scope or by an IP scope. In a single-request scope, a request is served, dropped, or challenged to verify the presence of a browser or a human user. In the IP scope, an IP address or a network range can be served or blocked. These security measures are, in many cases, inefficient. Attackers can either change their IP addresses, using cloud services, Internet Service Providers with dynamic IP allocation, or proxy networks. Additionally, the attackers can use IPs that are shared with many legitimate users, such as Internet Service Providers (ISPs) that use a common gateway (AOL for example), corporate networks, public wireless networks, etc.

For example, if an attacker wishes to brute-force a user-account, he will typically write a code that will attempt to login with different passwords until the attacker is blocked. The blocking may result from, for example, a web application firewall, large traffic velocities, or attempting too many wrong logins from a single IP address. When blocked, or even before being blocked, the attacking Bot will change its IP address and start a new session, and so on, until the attacked account has either been broken or suspended. This same methodology can be used for other types of hostile attacks, including content scraping, application layer Denial-of-Service attacks, form spamming, and SQL-injection.

There are several other methods used to identify end users, such as: login themes, federated identities, two-steps authentication, and ‘out-of-band’ authentication using PINs sent over text messages. It is also possible to verify a human presence through a challenge, known as CAPTCHA. However, these practices are used commonly for services that require a registration or a log-in process, or at least a completion of a meaningful transaction. The reason for that is that all of these measures interrupt the ‘natural flow’ of the service usage, consuming time and attention that will lead to high user churns. Additionally, websites wish to be easily accessible to legitimate Bots, such as those indexing their content for internet search engines. The security measures described above will typically function to block a search-engine Bot.

The ongoing problem of anonymity and/or forging identities over the web has naturally been a concern for the anti-fraud industry. For example, in e-commerce a merchant may wish to know if a user from an unknown IP address, without a cookie from previous sessions, and with new personal details, has not registered or shopped or committed fraud, before under another identity either on the merchant's site or any other commerce platform.

Accordingly, protective practices to deal with such merchant concerns have become widespread. One method involves extracting as many attributes as possible about the hardware or software being used by a potential customer, so as to create a “device fingerprint.” Such attributes may include: elements of the Transmission Control Protocol (TCP) stack that can tell the operation system version and machine's local time, the HTTP headers, and elements collected by a client-side script, such as the screen resolution, available fonts, default font size, browser add-ons and plug-ins, and so forth. The collection of such attributes can form a rather unique signature, as demonstrated by the Electronic Frontier Foundation on the Panopticlick project. See, for example, [http://panopticlick.eff.org/].

Additionally, a search for a tagging system that is more persistent than browser cookies has yielded a combination of methods that are typically named ‘ever-cookies.’ See, for example, [http://en.wikipedia.org/wiki/Evercookie/]. Typically, on an anti-fraud service, a device tag and its fingerprint are associated to the transactions that are conducted through the device (such as registrations, logins, purchasing) and to fraud reports. Accordingly, a merchant can connect to a device reputation service, which will take the tags/fingerprints from users conducting a transaction that is monitored for fraud, and will then respond with the device data and possibly a recommendation for the merchant, indicating whether the transaction should be accepted, rejected or further audited.

In comparison to the other security measures discussed above, the process of creating a device fingerprint is transparent and does not involve the end-user. However, the fingerprinting process is also used in meaningful online transactions and not necessarily throughout entire online user sessions. It can be used to mitigate fraud rather than to function as a security measure in mitigating hostile attacks or denying access from certain devices. The technological reasons for this are, basically, that a fingerprinting process may take between a few hundred milliseconds and a few seconds to complete. The fingerprinting process typically involves third-party services acting to collect the fingerprint and to match the collected data against device a reputation database. The procedure of sending the collected data to a central reputation database and delivering a response back to the protected service or website may take another few hundreds of milliseconds or more.

This leads to many potential problems in blocking attackers by the device fingerprint, such as:

1. The described methodology contradicts the real-time decision making approach that security measures typically need.
2. It is difficult to deny access from a specific device, even if it has a unique fingerprint. If the session is blocked, the device can initiate a new session (e.g., by deleting the session cookie). If the entire IP is blocked, this may harm legitimate users from that IP and the device may easily obtain a new IP address.
3. Stalling a user session until a fingerprinting process is finished and matched to a reputation database made may lead to a bad user experience, user churns, high server loads and interruption to search engines.

Applying the above-described methodology, that of taking the fingerprint in the background, while the user is free to interact, is ineffective. At best, fingerprinting will yield high ratios of false positives and false negatives. For example, it is not unlikely that a user will consume more services and request further pages before a fingerprinting process is complete. In such cases, a decision should be made what to do with these further requests. Denying the user's session may lead to high ratio of false-positives and possibly to blocking search engines and good Bots. Allowing the session means allowing potential exploitation. In anti-fraud, a typical fingerprinting process runs while the user is engaged in an interaction, such as filling-in a form, this security method is assuming that the fingerprinting process will end by the time the form is submitted. If no fingerprint data is available by the time the form has been completed, this will normally trigger a suspect and further auditing.

It is therefore clear, that in order to block attacking devices based on their fingerprint, there is a need for a system and a method that will take such fingerprints and inspect them without interrupting legitimate Bot traffic, with minimal interruption to legitimate users and yet allowing to take effective actions to block abusive devices. Such a method may provide for a user to identify an attacker, beyond the IP and the cookie/session, and to block malicious activity, even when an attacking Bot changes IP addresses and sessions, and yet provides for the user to allow legitimate traffic, even if the legitimate traffic originates from the same IP address.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a selective web traffic blocking system for executing effective actions to block hostile traffic and attacks, directed to an attacked asset, before damage is done, according to embodiments of the present invention;

FIG. 2 is a schematic flowchart illustrating a selective web traffic blocking method for executing effective actions to block hostile traffic and attacks according to embodiments of the present invention;

FIG. 3 is a flowchart illustrating a Background Device Inspection method according to embodiments of the present invention; and

FIG. 4 is a flowchart illustrating a Foreground Device Inspection method according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The disclosed system and method enables an end user browser to have evaluated web traffic by means of fingerprints without interrupting legitimate traffic. There is minimal interruption to legitimate users, but effective actions taken to block abusive traffic before damage can be done. The method identifies an attacker, beyond an IP and cookie/session, and blocks malicious activity, even when an attacking Bot changes IP addresses and sessions.

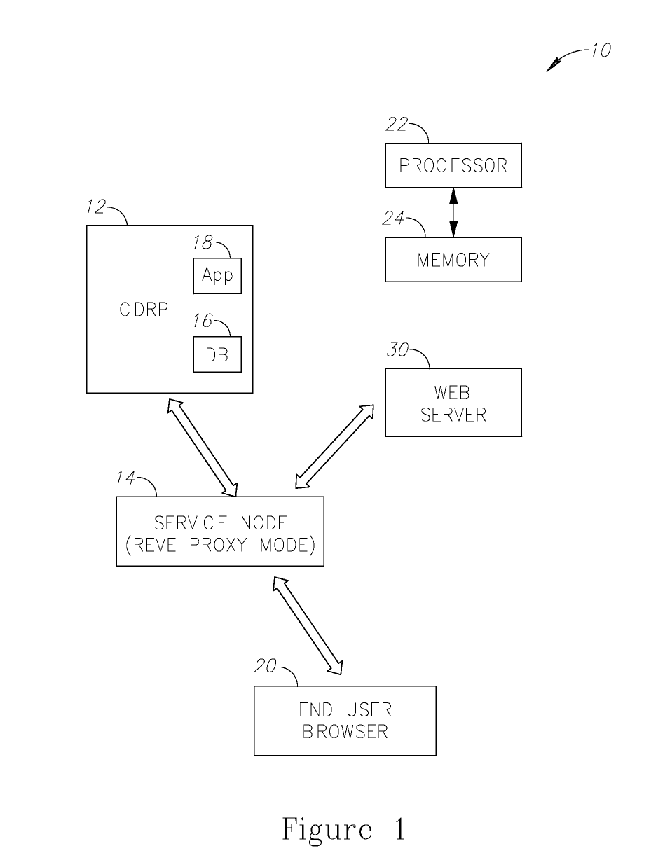

Reference is now made to FIG. 1, which is a schematic illustration of a selective web traffic blocking system 10 for executing effective actions to block hostile traffic and attacks, directed to an attacked asset, before damage is done, according to embodiments of the present invention. The system 10 further functions to inspect fingerprints without interrupting legitimate Bot traffic, while producing minimal interruption to legitimate users. System 10 may include a Centralized Device Reputation Center (CDRP) 12 and at least one Service Node (SN) 14. CDRP 12 and/or SN 14 may be executed and/or controlled by and/or included in processor 22. Additionally, system 10 may include at least one web server 30, and an end user browser 20.

Processor 22 may execute software or instructions (e.g. stored in memory 24) to carry out methods as disclosed herein. Memory 24 may include an article such as a computer or processor readable non-transitory storage medium, such as for example a memory card, a disk drive, or a USB flash memory encoding, including or storing instructions, e.g., computer-executable instructions. When executed by a processor or controller such as processor 22, the instructions stored and/or included in memory 24 may cause the processor or controller to carry out methods disclosed herein.

The CDRP 12 stores device attributes and reputations, either for a single website, for multiple websites, or globally for all websites being served via the one or more web servers 30. The CDRP 12 may typically include a database 16 (e.g., SQL or No-SQL) containing device identities (IDs), tags associated with the devices, and full attributes for the devices. Device tags may include, for example, temporary IDs, or tokens that are stored on the devices (e.g., either through browser cookies, flash cookies or other cached objects). Also, a session history and detected anomalies may be stored, per each device identity. Additionally, the CDRP 12 may include an application 18 that can match information collected through the SN 14 against the database 16, to find a device identity and its history according to the collected tag or device attributes of the subject device.

The SN 14 may “listen” to traffic inbound to the end user browser 20, and outbound from the web server 30 for possible intervention. The SN 14 may intervene according to pre-defined rules, or in accordance with rules that may be dynamically triggered through the CDRP 12, using one of more methods as described below. As used herein, the term “intervening” refers to the process of either: dropping, blocking, or otherwise modifying a response. Additionally, the SN 14 sends reports to the CDRP 12. For example, the SN 14 may send any collected device-fingerprinting attributes to the CDRP 12, and may further send some or all of requests, parameters, and headers to the CDRP 12.

In an exemplary embodiment, the SN 14 can work either through an API, such as a web-service, a web-server filter, a module (e.g., host-based solution), or an in-line network appliance. The in-line network appliance may include: a bridge, a reverse proxy, or a reverse proxy that can be located outside the data-center where the protected site/s are hosted, with the site's traffic routed through the reverse proxy via DNS configurations. All of these methodologies may allow or enable the SN 14 to collect data from the requests made to the protected site, such as the end user browser 20, and to take decisions (e.g., whether to serve a request, to block the request, or to alter the response), and to execute the decision or alternatively instruct the protected source to do so.

The ability of the SN 14 to listen to requests and modify responses, enables or allows the SN 14 to inject scripts into HTTP outbound traffic, and to thus trigger a device fingerprinting process. In the fingerprinting process, the end user browser 20 may send additional requests, either to the protected site, where the SN 14 can intercept the requests.

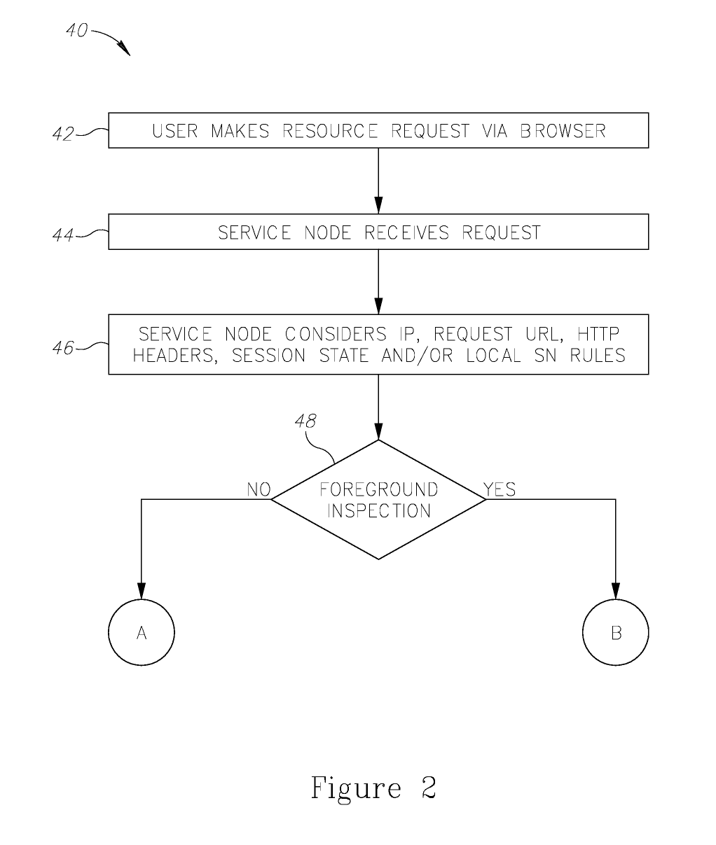

Reference is now made to FIG. 2, which is a schematic flowchart 40 illustrating a selective web traffic blocking method for executing effective actions to block hostile traffic and attacks according to embodiments of the present invention. In the exemplary method illustrated in FIG. 2, the user can make a request, via the end user browser 20, at step 42.

When a page request or a resource request event takes place, the SN 14 receives the request, at step 44. The SN 14 may, at step 46, consider one or more request parameters such as, for example: the IP information, the request URL, HTTP headers, the session state, and/or the local SN rules, after receiving the request. At decision block 48, the SN 14 may selectively apply either a Background Device Inspection, or a Foreground Device Inspection, in response to the received request.

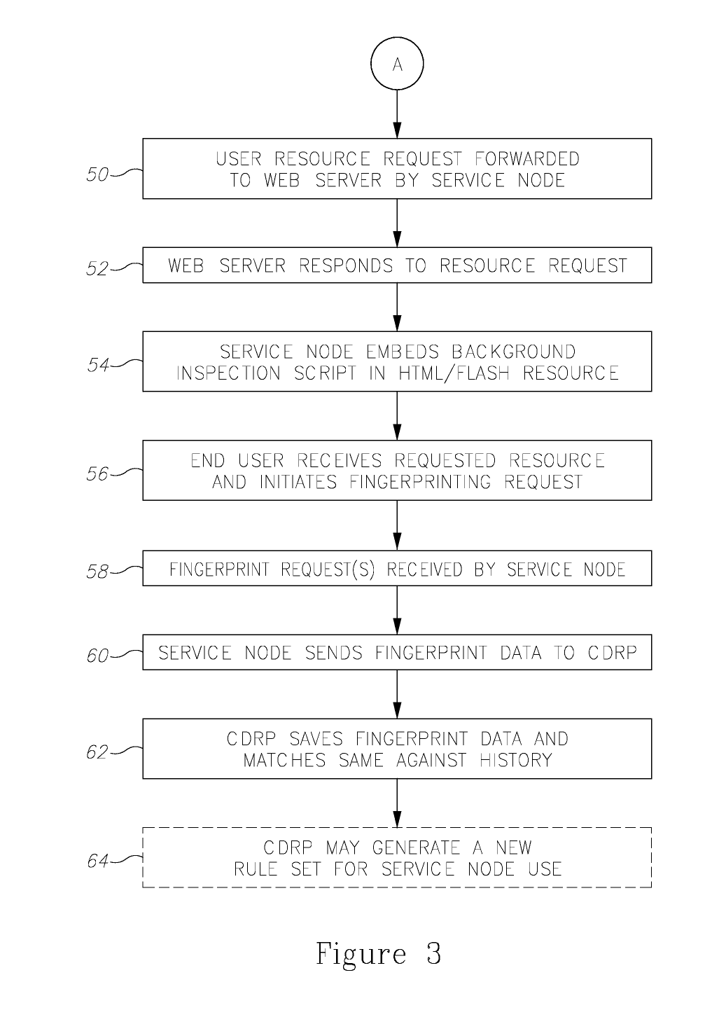

If, at decision block 48, the SN 14 elects to proceed with the Background Device Inspection method, the SN 14 may forward the user resource request to the web server 30, at step 50 in FIG. 3.

Reference is now made to FIG. 3, which is a flowchart illustrating a Background Device Inspection method according to embodiments of the present invention. At step 50, the SN 14 may forward the user resource request to the web server 30. The web server 30 may respond by transmitting the requested resource to the SN 14, at step 52. The SN 14 may then embed a background inspection script in the HTML/Flash resource received from the web server 30, at step 54.

At step 56, the end user browser 20 may receive the requested resource and initiate a fingerprint request. The end-user browser 20 may receive the requested page or resource while at the background, the embedded script may function to collect those device attributes that can be used to identify the device, and send the collected device attributes to the SN 14 and/or the CDRP 12, at step 58. In addition, the SN 14 may send fingerprint data to the CDRP 12, at step 60.

The CDRP 12 may then use the provided fingerprint data and try to match the data against previously obtained fingerprint data (i.e., fingerprint history). If required, the CDRP 12 may produce a new rule set, at optional step 64, and provide the new rule set to the SN 14.

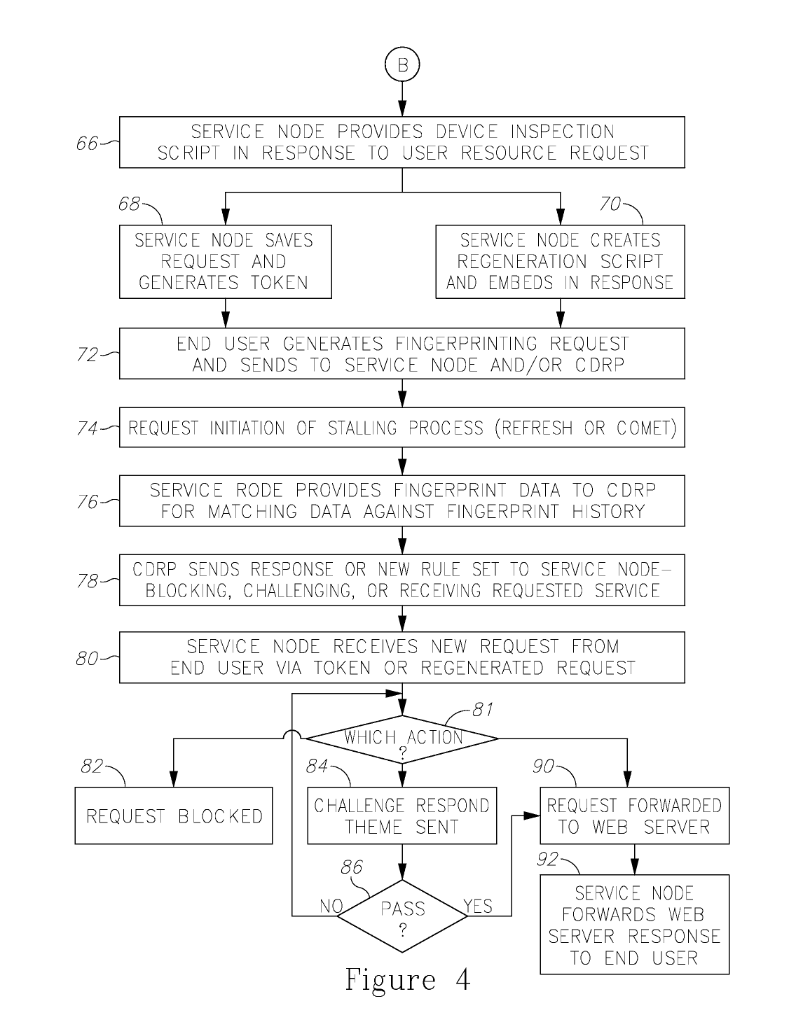

Reference is now made to FIG. 4, which is a flowchart illustrating a Foreground Device Inspection method according to embodiments of the present invention. If, at decision block 48, the SN 14 elects to proceed with the Foreground Device Inspection, the SN 14 may respond with a Device Inspection Script, at step 66 in FIG. 4, when a page or a resource has been requested by the end user browser 20. Preferably, the SN 14 responds in such a way that a series of events must take place before the resource request may receive the anticipated response. For example, the disclosed process may require that the Device Inspection Script be executed by the end user browser 20, prior to the CDRP 12 receiving information collected from the end user browser 20.

In an exemplary embodiment, the SN 14 may save the resource request and generate a token, at step 68. Alternatively, the SN 14 may create a regeneration script, and embed the regeneration script into the response sent to the end user browser 20 together with the device inspection script, at step 70. In either case, the end user browser 20 may initiate or generate a fingerprinting request, and transmit the request to either or both the SN 14 and the CDRP 12, at step 72.

In an exemplary embodiment, a “stalling” method may be implemented, at step 74, so as to delay the original request until a full inspection and risk assessment process have taken place. The stalling method is described in greater detail below. The SN 14 may respond to the end user request by providing fingerprint data to the CDRP 12, at step 76, for matching the fingerprint data against the fingerprint history.

The CDRP 12 may return a response or a new rule set to the SN 14, at step 78. In an exemplary embodiment, there may be three possible rules returned—block, challenge, and forward. That is, the CDRP 12 may indicate whether the requested session is being allowed, or whether the browser session is being challenged or sanctioned. The SN 14 may then receive a new request from the end user browser 20 via the token or a regenerated request, at step 80.

Then, at step 81 a decision as to ‘which action?’ is being taken. The actions are: ‘block’, ‘challenge’, and ‘forward’ as explained hereinafter.

If the SN 14 has been instructed to block the user request per the “block rule,” at step 82, the SN 14 may not further respond to the request and possibly a custom message may be sent.

If the SN 14 has been instructed to challenge the user request per the “challenge rule,” at step 84, a challenge response theme, such as providing a CAPTCHA challenge, may be sent. If the response to the challenge is not correct, the process continues to step 82, at which the request is blocked and the custom message may be sent, or there may be provided no further response.

If the SN 14 has been instructed to allow the session per the “forward rule,” (which is actually a default state that occurs only when ‘block’ and ‘challenge’ don't occur) at step 90, the resource request can be forwarded to the web server 30. The SN 14 may provide to the end user browser 20, at step 92, the response received from the web server 30.

Whether background or foreground inspections are executed, a new rule set may be provided to SN 14 by CDRP 12 and embedded in SN 14 as a local SN rule such as a block rule, or a challenge rule. A challenge may include a rule instructing to apply background or foreground inspection with regard to end user browser 20 and may be provided to SN 14 by CDRP 12 and embedded in SN 14 as a local SN rule. In case foreground check is applied, next time a request from the same end user browser 20 is received, no matter from which IP or session, SN 14 may identify end user browser 20 based on the fingerprint data and apply the local SN rule. Advantageously by combing a block rule that includes specified fingerprints with the aforementioned foreground rules a hermetic blocking may be achieved.

In the process of allowing or blocking an attacker's origin accurately, for a particular page or resource request, the SN 14 initially establishes whether the SN 14 has been instructed to: (i) apply a Background Device Inspection, or (ii) enforce a Foreground Device Inspection, as explained above. The type of inspection to be executed may determined by rules that are either: (i) preconfigured, (ii) dynamic, or (iii) a combination of dynamic and pre-configured. Such rules can take under consideration parameters, including but not limited to, the IP address, the IP range, an IP's country and organization, the request number within the session sequence, one or more HTTP header values (such as, for example, cookies and cached items that a designated JS can save as cookies), and the URL or resource being requested.

An exemplary embodiment of a rule-set that can be executed by the SN 14 may include the steps of:

1. If neither method of Device Inspection has been executed and completed previously in a particular session, then enforce a Foreground Device Inspection when a user calls a certain resource (e.g., a URL or a URL mask);
2. If neither method of Device Inspection has been executed and completed previously in the session, then enforce a Foreground Device Inspection when a user makes a POST request;
3. If neither method of Device Inspection has been executed and completed previously in the session, then enforce a Foreground Device Inspection when the session reaches a pre-determined number of requests;
4. Enforce a Foreground Device Inspection when a session starts from listed IPs or IP ranges; and
5. If neither method of Device Inspection has been executed and completed previously in the session, and a Foreground Device Inspection is not triggered by a rule, embed a Background Device Inspection to any request.

The outcome of the above rule-set is an attempt to execute a device fingerprinting process in the background per each page request a user is making, and enforcing the process if the user makes a certain amount of requests without completing the process, or makes requests that are potentially more sensitive, such as post requests or calls to certain protected resources.

As stated above, the CDRP 12 or the SN 14 may trigger rules to enforce a Foreground Device Inspection in cases that require the Inspection in response to the resource's or action's sensitivity, or in response to suspected attacks sources or patterns. If, for example, an IP address or IP address range is suspected as having a bad origin, a rule may be triggered to enforce a Foreground Device Inspection for each new session originating from suspect IPs. Alternatively, if a certain resource is believed to be attacked, due to a high request velocity or a slow response, a rule can be triggered to enforce a Foreground Device Inspection on each session in which a Device Inspection has not taken place, and a request to this resource is made.

An exemplary method functioning to stall a request for a Device Inspection may include two key elements. The first element includes stalling until the Device Inspection is complete, and the results or instructions are transmitted from the CDRP 12 to the SN 14. The second element includes regenerating the original request after the stall has been initiated or completed.

The regeneration of the request may be executed in one of the two following methods (“Regeneration Scripts”):

1. The SN 14 may send, with the Foreground Device Inspection script, another script that will regenerate the original request by calling the same URL or by generating and submitting a web form that to the same URL, containing fields and values that include all POST parameters that appeared on the original request.
2. The SN 14 may store the original request's parameters (such as URL and GET/POST values) temporarily, and may generate a token, that will be sent with the Foreground Device Inspection script. When the end user browser 20 sends the token, the SN 14 may retrieve from its storage all request parameters, and may initiate such HTTP requests to the web server, which will be then returned to the end user browser 20. This action may apply primarily when the SN 14 serves as a proxy.

In an exemplary embodiment, the process of stalling a request (see step 72, above) may be executed in one of the two following methods:

1. “Blind Method” or “Asymmetric Method”. The SN 14 may send a script that is fired after the full execution of the Device Fingerprinting procedures on the client. This script will regenerate the request in one of the two Regeneration Scripts. The SN 14 may respond with another Regeneration Script or if the SN 14 has not yet received the Device Inspection's results or instructions from the CDRP 12. Otherwise, the SN 14 may respond with the challenge or with sanction that the SN 14 has been instructed to execute. This will lead to a HTTP request-response loop until the inspection is completed and results are sent back to the SN 14. Such a loop may include an execution interval, so a new request will be generated each given time (for example, one second). The loop may include a “time-out,” after which a default decision may be made. Accordingly, after four seconds or four such loops, for example, the SN 14 may authorize or deny the request, even though the SN 14 has not received orders from the CDRP 12. This timeout mechanism can be used as a fail-over if the CDRP 12 is unavailable, and if it is desired that the CDRP 12 is to respond only in cases in which a challenge or a sanction has to be taken.
2. “Symmetric Method”. The SN 14 may send a script that is fired before or after the full execution of the Device Fingerprinting procedures on the client. This script will establish a connection with the web server 30, or with the SN 14 that is a proxy, and then wait for a pushed message that will trigger a Regeneration Script. This methodology is sometimes referred to as “Comet,” “Reverse Ajax,” or “Long Polling.”

The CDRP 12, which receives the device tags or fingerprint attributes (either directly from the device or indirectly from the SN 14), may search the device either by its tag or by a full or partial combination of fingerprint attributes. According to the device or devices and histories found, the CDRP 12 may decide whether to challenge or block the session or request, or to allow it. The CDRP 12 may decide by the device's history (such as detected anomalies or good behaviors), or according to the attributes of the device (such as the presence of add-ons, fonts, cache, cookies, use of anonymous proxies and so on). In an exemplary embodiment, it may be necessary only that the CDRP 12 will be able to store and retrieve device identities, tags and attributes and information about the sessions conducted, and to take decisions based on this stored data.

The system 10 may function to allow a situation in which users devices/browsers are fingerprinted during their sessions and, in certain scenarios, that are dynamic and configurable. Requests may trigger a full device inspection procedure, which is a three-tier procedure including the end-client, a web-server or a proxy and a central device reputation. The central device reputation is preferably completed before the request hits the protected server or resource, and the anticipated response or action is allowed. This adds at least two capabilities that are necessary but which may not be found in conventional web security tools: (i) the ability to block a device involved in attack or abuse, even when it changes its IP address, and (ii) the ability to block such devices accurately when they use IP addresses of legitimate traffic.

For example, a user who wishes to brute-force an account's password and uses the same IP address as other ‘good’ users, will typically reset the session after each unsuccessful attempt. With the same rule-set described above, the user will not be able to generate a POST request without passing through a device inspection first. If any new session does not complete a full device inspection by the time it makes the POST request of the new attempted login/password, it will be forced to complete such an inspection upon the POST request.

The end user browser 20 will receive a script which will initiate the fingerprinting procedure. The full fingerprint data will be sent to the CDRP 12. The CDRP 12 may then decide to block the device's session, challenge it or trigger a sanction, based on data such as, for example, that this device generates numerous new sessions (typically, deleting all cookies), or makes more than the typical or maximum allowed post requests, and so forth. The device will not be able to try further passwords. However, other users from this very same IP will be able to access the site and log-in with their passwords.

Unless otherwise defined, all technical and scientific terms used herein have the same meaning as commonly understood by one of ordinary skill in the art to which this invention belongs. The methods and examples provided herein are illustrative only and not intended to be limiting.

Implementation of the method and system of the present invention involves performing or completing certain selected tasks or stages manually, automatically, or a combination thereof. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

While the invention has been described with respect to a limited number of embodiments, it will be appreciated that many variations, modifications and other applications of the invention may be made. Many of the specific details of certain embodiments of the invention are set forth in the above description and related drawings to provide a thorough understanding of such embodiments. One skilled in the art will understand, however, that the present invention may be practiced without several of the details described in the above description.

1. A selective web traffic blocking method comprising:
receiving a resource request from a user to receive a resource from a web server;
collecting data from the received request; and
applying either background device inspection or foreground device inspection in response to the received request, based on the collected data.

2. The method of claim 1, wherein said data collected from the received resource request includes a list comprising: IP information, the request URL, and at least one of: HTTP headers, the session state, and device attributes.

3. The method of claim 1, wherein applying a background device inspection comprises:
forwarding the resource request to said web server;
receiving the requested resource from said web server; and
embedding a background inspection script and forwarding the requested source to a user with the embedded background inspection script.

4. The method of claim 3, further comprising receiving fingerprint data in response to inspection, said receiving fingerprint data comprises receiving device attributes data collected by said background inspection script.

5. The method of claim 4, further comprising: sending the collected data to the CDRP, and matching at the CDRP, the received device attributes data against previously obtained device data and providing a rule how to respond to said user based on said matching.

6. The method of claim 1 wherein applying a foreground device inspection comprises responding to said resource request with a device inspection script while stalling the web server response to said request.

7. The method of claim 6, further comprising receiving fingerprint data in response to inspection, said receiving fingerprint data comprises receiving device attributes data collected by said inspection script.

8. The method of claim 7, comprising: sending the collected data to the CDRP, and matching at the CDRP the received device attributes data against previously obtained device data and providing a rule how to respond to said user based on said matching.

9. The method of claim 1, wherein the provided rule is one of a list comprising: a block rule block the source request, a challenge rule to challenge the user request and a default state in which the resource request is forwarded to the web server.

10. A processor readable non-transitory storage medium storing computer-executable instructions thereon, wherein, when executed by a processor, the instructions cause the processor to:
collect data from a received resource request from a user to a web server; and
apply either background device inspection or foreground device inspection in response to the received request, based on the collected data.

11. The storage medium of claim 10, wherein the instructions cause the processor to collect from the received resource request data including at least one of a list comprising: IP information, the request URL, and at least one of: HTTP headers, the session state, and device attributes.

12. The storage medium of claim 10, wherein when applying a background device inspection, the instructions cause the processor to:
forward the resource request to said web server;
receive the requested resource from said web server; and
embed a background inspection script and forward the requested source to a user with the embedded background inspection script.

13. The storage medium of claim 12, wherein the instructions cause the processor to receive fingerprint data in response to inspection, said receiving fingerprint data comprising receiving device attributes data collected by said background inspection script.

14. The storage medium of claim 13, wherein the collected data is sent to the CDRP, and wherein the instructions cause the processor to match at the CDRP the received device attributes data against previously obtained device data and to provide a rule how to respond to said user based on said matching.

15. The storage medium of claim 10, wherein when applying a foreground device inspection, the instructions cause the processor to respond to said resource request with a device inspection script while stalling the resource request.

16. The storage medium of claim 15, wherein the instructions cause the processor to receive fingerprint data in response to inspection, said receiving fingerprint data comprising receiving device attributes data collected by said inspection script.

17. The storage medium of claim 16, wherein the collected data is sent to the CDRP, and wherein the instructions cause the processor to match at the CDRP and wherein the instructions cause the processor to match the received device attributes data against previously obtained device data and to provide a rule how to respond to said user based on said matching.

18. The storage medium of claim 10, wherein the provided rule is one of a list comprising: a block rule to block the source request, a challenge rule to challenge the user request and a default state in which the resource request is forwarded to the web server.

19. A system for selective web traffic blocking, the system comprising:
a service node to receive a resource request from a user to receive a resource from a web server, to collect data from the received request and to apply either background device inspection or foreground device inspection in response to the received request, based on the collected data; and
a centralized device reputation center controlled by a processor to receive fingerprint data in response to inspection and to provide to said service node a rule how to respond to said user based on said fingerprint data.

20. The system of claim 19, wherein said data collected from the received resource request includes at least one of a list comprising: IP information, the request URL, and at least one of: HTTP headers, the session state, and device attributes.

21. The system of claim 19, wherein when applying a background device inspection, the service node is to forward the resource request to said web server, receive the requested resource from said web server, embed a background inspection script and forward the requested source to a user with the embedded background inspection script.

22. The system of claim 21, wherein said centralized device reputation center is to receive fingerprint data in response to inspection by receiving device attributes data collected by said background inspection script.

23. The system of claim 22, wherein the collected data is sent to the centralized device reputation center, and wherein the centralized device reputation center is configured to match the received device attributes data against previously obtained device data and to provide to said service node a rule how to respond to said user, based on said matching.

24. The system of claim 19, wherein when applying a foreground device inspection, the service node is to respond to said resource request with a device inspection script while stalling the resource request.

25. The system of claim 24, wherein said centralized device reputation center is configured to receive fingerprint data in response to inspection by a client's browser yielding attributes data collected by said inspection script.

26. The system of claim 25, wherein the collected data is sent to the centralized device reputation center, and wherein the centralized device reputation center is configured to match the received device attributes data against previously obtained device data and to provide to said service node a rule how to respond to said user, based on said matching.

27. The system of claim 19, wherein the provided rule is one of a list comprising: a block rule to block the source request, a challenge rule to challenge the user request and a forward default state in which the resource request is forwarded to the web server.
